(19) United States
(12) Patent Application Publication
(10) Pub. No.: US 2011/0261300 A1
(43) Pub. Date: Oct. 27, 2011

(54) AREA SENSOR AND DISPLAY DEVICE HAVING AREA SENSOR

(76) Inventors: Shinichi Miyazaki, Osaka (JP); Masakazu Wada, Osaka (JP); Norikazu Hohshi, Osaka (JP); Kengo Takahama, Osaka (JP); Toshiaki Nakagawa, Osaka (JP)

(21) Appl. No.: 13/126,574

(22) PCT Filed: Jul. 28, 2009
(86) PCT No.: PCT/JP2009/063437

§ 371 Date: Jul. 8, 2011

(30) Foreign Application Priority Data
Nov. 4, 2008 (JP) 2008-283637

(51) Int. Cl. G02F 1/1335; G01B 11/14

(52) U.S. Cl. 349/104; 356/614

(57) ABSTRACT

An area sensor and an area-sensor-equipped display device are provided which can clearly discriminate between the presence and absence of a finger or input pen touching a panel surface. A liquid crystal display device (100) of the present invention includes: a liquid crystal panel (position detecting section) (20), provided with a plurality of light sensor elements (30) that detects the intensity of received light, which detects the position of an input through detection of an image on a panel surface (detector surface) (100a) by the light sensor elements (30); and a reflectance changing section (45), provided on that side of the liquid crystal panel (20) which faces the panel surface (100a), which effects a change in reflectance of light when pressure is applied to the panel surface (100a). The liquid crystal display device includes: an infrared light blocking filter (90) and an ultraviolet light blocking filter (40a), both provided on that side of the reflectance changing section (45) which faces the panel surface (100a), which do not transmit infrared light and ultraviolet light, respectively; and visible light blocking filters (31) provided on those respective sides of the light sensor elements (30) which face the panel surface (100a), which do not transmit visible light.

### TECHNICAL FIELD

The present invention relates to: an area sensor, including light sensor elements, which detects the position of an input from an outside source; and a display device having such an area sensor built-in.

### BACKGROUND ART

Among display devices, such as liquid crystal display devices, which are under development, there have been touch-panel-integrated display devices each having a touch panel (area sensor) function that makes it possible to detect the position of contact of an input pen with the panel surface.

Mainstream examples of conventional touch-panel-integrated display devices include a resistive type (which, when pressed, detects the position of an input through contact between upper and lower conductive substrates) and a capacitance type (which detects the position of an input by detecting a change in capacitance of a place touched).

Meanwhile, in recent years, the development of a liquid crystal display device having a light sensor element such as a photodiode or a phototransistor provided in each pixel (or in each unit of a plurality of pixels) within an image display region has been advanced (e.g., see Patent Literature 1). By thus having a light sensor element built in each pixel, an ordinary liquid crystal display device can fulfill a function as an area sensor (specifically, a scanner function, a touch panel function, etc.). That is, by such light sensor elements fulfilling a function as an area sensor, a display device integrated with a touch panel (or with a scanner) can be achieved.

### CITATION LIST

Patent Literature 1
Japanese Patent Application Publication, Tokukai, No. 2006-18219 (Publication Date: Jan. 19, 2006)

Patent Literature 2
Japanese Patent Application Publication, Tokukai, No. 2001-67180 (Publication Date: Mar. 16, 2001)

### SUMMARY OF INVENTION

### Technical Problem

When a liquid crystal display device including light sensor elements is used as a display device having a touch panel function, a pen or finger reflected on the display panel is captured as an image by the light sensor elements, and position detection is carried out by detecting the position of the tip of the pen or finger.

When touch panel input are done with a finger or pen into such a display device having a touch panel function, the amount of light that is received by the light sensor elements built in the liquid crystal display device does not vary between a case where the tip of the finger or pen is in contact with the panel surface and a case where it is not. For this reason, it is difficult to clearly discriminate between a case where the finger or input pen is in touch with the display panel and a case where it is not.

Such a problem of difficulty in discriminating between the presence and absence of a touch occurs not only in an area sensor built in a display device, but also in an area sensor using light sensor elements (e.g., an optical pointing input device described in Patent Literature 2, etc.).

Furthermore, in such an area sensor using light sensor elements, there is no system that blocks outside light; therefore light around the area sensor enters the light sensor elements. This increases noise in the image, thus making it difficult to carry out position detection.

Further, in such an area sensor using light sensor elements, differences in reflectance and transmittance between objects to be detected lead to changes in amount of reflected light and transmitted light that enter the light sensor elements. This makes it necessary to carry out detection differently for different objects to be detected.

The present invention has been made in view of the foregoing problems, and it is an object of the present invention to provide: an area sensor capable of clearly discriminating between the presence and absence of a finger or input pen touching a display panel; and a display device having such an area sensor.

### Solution to Problem

In order to solve the foregoing problems, an area sensor according to the present invention is an area sensor for detecting the position of an input from an outside source by detecting an image on a detector surface, the area sensor including: a position detecting section, provided with a plurality of light sensor elements that detects the intensity of received light, which detects the position of an input through detection of an image on the detector surface by the light sensor elements; and a reflectance changing section, provided on that side of the position detecting section which faces the detector surface, which effects a change in reflectance of light when pressure is applied to the detector surface, the area sensor further including: an infrared light blocking filter and an ultraviolet light blocking filter both provided on that side of the reflectance changing section which faces the detector surface; and visible light blocking filters provided on those respective sides of the light sensor elements which face the detector surface and between the position detecting section and the reflectance changing section.

According to the foregoing configuration, the provision of the reflectance changing section allows the reflectance of light from a light-emitting section or the like to vary between the presence and absence of pressure being applied to the detector surface. This allows the area sensor according to the present invention to clearly discriminate between the presence and absence of a finger, an input pen, or the like touching the detector surface.

Since, according to the foregoing configuration, the area sensor includes the infrared light blocking filter and the ultraviolet light blocking filter, both provided on that side of the reflectance changing section which faces the detector surface, which do not transmit infrared light and ultraviolet light, respectively, infrared and ultraviolet light contained in outside light can be blocked; therefore, noise in the image can be reduced. Further, since, according to the foregoing configuration, the area sensor includes the visible light blocking filters, provided on those respective sides of the light sensor elements which face the detector surface and between the position detecting section and the reflectance changing section, which do not transmit visible light, visible light contained in the outside light can be blocked; therefore, the noise in the image can be reduced. This allows the area sensor according to the present invention to carry out stable discrimination.

Further, since, according to the foregoing configuration, the reflectance changing section is provided on that side of the position detecting section which faces the detector surface, light whose reflectance has been changed by the reflectance changing section can be made to enter the position detecting section.

Further, the area sensor according to the present invention may further include a light-emitting section for irradiating the position detecting section with light containing at least infrared light or ultraviolet light from behind.

Further, the area sensor according to the present invention may be configured such that the reflectance changing section lowers reflectance when under pressure.

Further, the area sensor according to the present invention may be configured such that the reflectance changing section is a laminate of (i) an elastic film and (ii) a flat-plate transparent substrate.

Further, the area sensor according to the present invention may be configured such that the elastic film has irregularities formed therein.

Further, the area sensor according to the present invention may be configured such that the reflectance changing section has at least two elastic films and an air layer formed between the two elastic films with no pressure being applied to the detector surface, and is structured such that the two elastic films makes contact with each other when pressure is applied to the detector surface.

Further, the area sensor according to the present invention may be configured such that the reflectance changing section has distance maintaining parts provided on at least either of the two elastic films so that the air layer is formed.

A display device according to the present invention has a display panel including one of the foregoing area sensors.

In order to solve the foregoing problems, a liquid crystal display device according to the present invention is a liquid crystal display device (i) including a liquid crystal panel having an active matrix substrate, a counter substrate, and a liquid crystal layer disposed therebetween and (ii) having an area sensor function of detecting the position of an input from an outside source by detecting an image on a panel surface, the liquid crystal display device including: a position detecting section, provided with a plurality of light sensor elements that detects the intensity of received light, which detects the position of an input from an outside source through detection of an image on the panel surface by the light sensor elements; and a reflectance changing section, provided on that side of the position detecting section which faces the panel surface, which effects a change in reflectance of light when pressure is applied to the panel surface, the liquid crystal display device further including: an infrared light blocking filter and an ultraviolet light blocking filter both provided on that side of the reflectance changing section which faces the panel surface; and visible light blocking filters provided on those respective sides of the light sensor elements which face the panel surface and between the position detecting section and the reflectance changing section.

According to the foregoing configuration, the provision of the reflectance changing section allows the reflectance of light from a light-emitting section or the like to vary between the presence and absence of pressure being applied to the detector surface. This allows the area sensor according to the present invention to clearly discriminate between the presence and absence of a finger, an input pen, or the like touching the panel surface.

Since, according to the foregoing configuration, the area sensor includes the infrared light blocking filter and the ultraviolet light blocking filter, both provided on that side of the reflectance changing section which faces the panel surface, which do not transmit infrared light and ultraviolet light, respectively, infrared and ultraviolet light contained in outside light can be blocked; therefore, noise in the image can be reduced. Further, since, according to the foregoing configuration, the area sensor includes the visible light blocking filters, provided on those respective sides of the light sensor elements which face the panel surface and between the position detecting section and the reflectance changing section, which do not transmit visible light, visible light contained in the outside light can be blocked; therefore, the noise in the image can be reduced. This allows the area sensor according to the present invention to carry out stable discrimination.

Further, since, according to the foregoing configuration, the reflectance changing section is provided on that side of the position detecting section which faces the panel surface, light whose reflectance has been changed by the reflectance changing section can be made to enter the position detecting section.

Further, the liquid crystal display device according to the present invention may be configured such that the ultraviolet light blocking filter is a polarizing plate.

Further, the liquid crystal display device according to the present invention may further include a backlight for irradiating the liquid crystal panel with light containing at least infrared light or ultraviolet light from behind.

Further, the liquid crystal display device according to the present invention may be configured such that the reflectance changing section lowers reflectance when under pressure.

Further, the liquid crystal display device according to the present invention may be configured such that: the liquid crystal panel is provided between two polarizing plates disposed opposite each other; the reflectance changing section is a laminate of (i) that one of the polarizing plates which is provided toward an image display surface and (ii) an elastic film; and the elastic film is disposed between the liquid crystal panel and the polarizing plate provided toward the image display surface.

Further, the liquid crystal display device according to the present invention may be configured such that the elastic film has irregularities formed therein.

Further, the liquid crystal display device according to the present invention may be configured such that the reflectance changing section has at least two elastic films and an air layer formed between the two elastic films with no pressure being applied to the panel surface, and is structured such that the two elastic films makes contact with each other when pressure is applied to the panel surface.

### Advantageous Effects of Invention

The present invention brings about an effect of clearly discriminating between the presence and absence of a finger or input pen touching the display panel.

### BRIEF DESCRIPTION OF DRAWINGS

FIG. 1 is a schematic view showing the configuration of a liquid crystal display device according to an embodiment of the present invention.

FIG. 2 is a cross-sectional view showing an example of the structure of a reflectance changing section provided in the liquid crystal display device shown in FIG. 1.

FIG. 3 is an enlarged view of part of the reflectance changing section shown in FIG. 2, with no pressure being applied to the panel surface.

FIG. 4, showing diagrams with pressure being applied to the panel surface in an embodiment of the present invention, shows (a) an enlarged view of part of the reflectance changing section shown in FIG. 2 and (b) an image that is detected by the light sensor elements when a finger touches the panel surface.

FIG. 5 is a schematic view showing an output from the light sensor elements when a finger touches the panel surface of the liquid crystal display device shown in FIG. 1.

FIG. 6, showing cross-sectional views showing another example of a reflectance changing section of the present invention, shows (a) a state in which there is no finger touching the detector surface and (b) a state in which there is a finger touching the detector surface.

FIG. 7 is a schematic view showing another example configuration (Embodiment 1) of a liquid crystal display device of the present invention.

FIG. 8, showing schematic views showing images that are detected by light sensor elements in a liquid crystal display device of the present invention or a conventional liquid crystal display device, shows (a) images that are detected by light sensor elements in a conventional area-sensor-equipped liquid crystal display device and (b) images that are detected by light sensor elements in a liquid crystal display device of the present invention.

FIG. 9 is a schematic view showing the configuration (Embodiment 2) of an area sensor according to an embodiment of the present invention.

FIG. 10 is a schematic view showing another example configuration (Embodiment 3) of a liquid crystal display device of the present invention.

FIG. 11 is a cross-sectional view showing the structure of a reflectance changing section provided in the liquid crystal display device shown in FIG. 10.

FIG. 12 is an enlarged view of part of the reflectance changing section shown in FIG. 11, with no pressure being applied to the panel surface.

FIG. 13, showing diagrams with pressure being applied to the panel surface in another embodiment (Embodiment 3) of the present invention, shows (a) an enlarged view of part of the reflectance changing section shown in FIG. 11 and (b) an image that is detected by the light sensor elements when a finger touches the panel surface.

FIG. 14 is a schematic view showing an output from the light sensor elements when a finger touches the panel surface of the liquid crystal display device shown in FIG. 10.

FIG. 15 is a schematic view showing still another example configuration (Embodiment 3) of a liquid crystal display device of the present invention.

FIG. 16 is a schematic diagram showing the configuration (Embodiment 4) of an area sensor according to another embodiment of the present invention.

FIG. 17 is a cross-sectional view showing the configuration of a conventional area-sensor-equipped liquid crystal display device.

FIG. 18 is a schematic view showing an output from the light sensor elements when a finger touches the panel surface of the liquid crystal display device shown in FIG. 17.

### DESCRIPTION OF EMBODIMENTS

### Embodiment 1

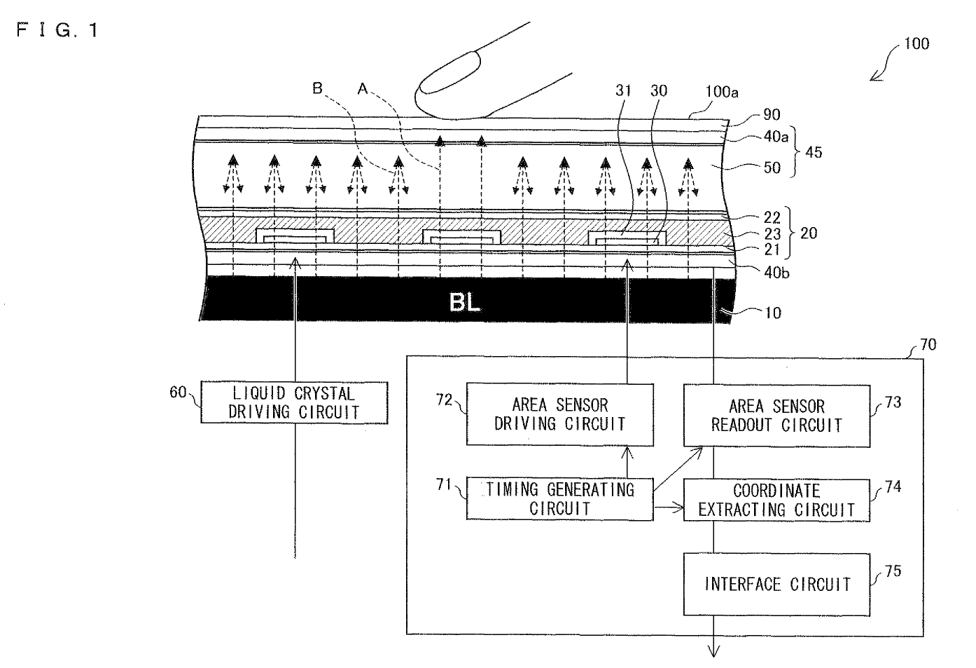

An embodiment of the present invention is described below with reference to FIGS. 1 through 5. It should be noted that the present invention is not limited to this.

The present embodiment describes a touch-panel-integrated liquid crystal display device having an area sensor function (specifically, a touch panel function).

The configuration of a touch-panel-integrated liquid crystal display device of the present embodiment is described with reference to FIG. 1. A touch-panel-integrated liquid crystal display device 100 shown in FIG. 1 (also simply called “liquid crystal display device 100”) has a touch panel function of detecting the position of an input through detection of an image on a surface of a display panel by a light sensor element provided in each pixel.

As shown in FIG. 1, the touch-panel-integrated liquid crystal display device 100 of the present embodiment includes: a liquid crystal panel 20 (position detecting section); and a backlight 10 (light-emitting section), provided toward a back surface of the liquid crystal panel 20 (toward that side of the liquid crystal panel 20 which faces the backlight 10), which irradiates the liquid crystal panel with light. It should be noted that although the touch-panel-integrated liquid crystal display device 100 of the present embodiment includes the backlight 10, it is encompassed in the scope of the present invention even if it does not include the backlight 10, so long as the liquid crystal panel 20 can be irradiated with light containing at least infrared light or ultraviolet light from behind. It should be noted that the backlight 10 emits light at least containing infrared light or ultraviolet light.

The liquid crystal panel 20 includes: an active matrix substrate 21 having a large number of pixels arrayed in a matrix manner; a counter substrate 22 disposed opposite the active matrix substrate 21; and a liquid crystal layer 23, sandwiched between the two substrates, which serves as a display medium. It should be noted that in the present embodiment, the liquid crystal panel 20 is not limited to any particular display mode and can adopt any display mode such as the TN mode, the IPS mode, the VA mode, etc.

Further, on outer sides of the liquid crystal panel 20, there are provided a front-side polarizing plate 40a and a back-side polarizing plate 40b, respectively, with the liquid crystal panel 20 sandwiched therebetween.

Each of the polarizing plates 40a and 40b plays a role as a polarizer. For example, in cases where a liquid material sealed in the liquid crystal layer is of a vertical alignment type, a normally black mode liquid crystal display device can be achieved by disposing the front-side polarizing plate 40a and the back-side polarizing plate 40b so that their respective directions of polarization are in a crossed Nicols relationship with each other.

Provided between the front-side polarizing plate 40a and the liquid crystal panel 20 is an elastic film 50. In the liquid crystal display device 100 of the present embodiment, the elastic film 50 and the front-side polarizing plate 40a forms a laminated structure that serves as a reflectance changing section 45 which effects a change in reflectance of light from the backlight 10 when pressure is applied to the surface of the device (detector surface 100a of the touch panel).

The active matrix substrate 21 is provided with TFTs (not illustrated) serving as switching elements for driving the pixels, an alignment film (not illustrated), light sensor elements 30, etc.

Further, the counter substrate 22 is provided, albeit not illustrated, with a color filter layer, a counter electrode, an alignment film, etc. The color filter layer is constituted by a coloring section having red (R), green (G), and blue (B) and a black matrix.

As mentioned above, the touch-panel-integrated liquid crystal display device 100 of the present embodiment has a light sensor element 30 provided in each pixel region, whereby an area sensor is achieved. Moreover, it is possible to, when a finger or input pen makes contact with a specific position on the surface (detector surface 100a) of the liquid crystal panel 20, have the light sensor elements 30 read that position, to input information into the device, and to execute an intended operation. Thus, in the touch-panel-integrated liquid crystal display device 100 of the present embodiment, the touch panel function can be achieved by the light sensor elements 30.

Each of the light sensor elements 30 is formed by a photodiode or a phototransistor and detects the amount of received light by passing therethrough a current corresponding to the intensity of the received light. The TFTs and the light sensor elements 30 may be those formed monolithically by substantially the same process on the active matrix substrate 21. That is, some of the components of each of the light sensor elements 30 may be formed at the same time as some of the components of each of the TFTs. Such a method for forming light sensor elements can be carried out according to a conventionally publicly known method for manufacturing a liquid crystal display device having light sensor elements built-in.

It should be noted that the present invention does not necessarily have a light sensor element provided in each pixel and may, for example, have a light sensor provided in each pixel having a R, G, or B color filter.

Further, the touch-panel-integrated liquid crystal display device 100 of the present embodiment has visible light blocking filters 31, provided on those respective sides of the light sensor elements 30 which face the detector surface 100a and between the liquid crystal panel 20 (active matrix substrate 21 of the liquid crystal panel 20) and the reflectance changing section 45, which does not transmit visible light. Furthermore, the touch-panel-integrated liquid crystal display device 100 of the present embodiment has an infrared light blocking filter 90, provided on that side of the reflectance changing section 45 which faces the detector surface 100a, which does not transmit infrared light. It should be noted that in the touch-panel-integrated liquid crystal display device 100 of the present embodiment, the front-side polarizing plate 40a works as an ultraviolet light blocking filter that does not transmit ultraviolet light.

It should be noted here that although, in the touch-panel-integrated liquid crystal display device 100 of the present embodiment, the infrared light blocking filter 90 is located closer to the detector surface 100a than the ultraviolet light blocking filter (front-side polarizing plate 40a) is, this does not imply any particular limitation. Even if the ultraviolet light blocking filter (front-side polarizing plate 40a) is located closer to the detector surface 100a than the infrared light blocking filter 90 is, it is encompassed in the scope of the present invention.

The following specifically describes the workings of the visible light blocking filters 31, of the infrared light blocking filter 90, and of the ultraviolet light blocking filter (front-side polarizing plate 40a) and the types of light that enter the light sensor elements 30.

In the touch-panel-integrated liquid crystal display device 100 of the present embodiment, the infrared light blocking filter 90, the ultraviolet light blocking filter (front-side polarizing plate 40a), and the visible light blocking filters 31 block infrared, ultraviolet, and visible light contained in outside light, respectively, so that the outside light does not enter the light sensor elements 30.

Further, the infrared light blocking filter 90, the ultraviolet light blocking filter (front-side polarizing plate 40a), and the visible light blocking filters 31 block infrared, ultraviolet, and visible light contained in reflected light to be detected, respectively, so that the reflected light to be detected does not enter the light sensor elements 30.

Further, that portion of infrared light contained in light emitted from the backlight 10 which has been transmitted through the reflectance changing section 45 is absorbed by the infrared light blocking filter 90. Meanwhile, that portion of the infrared light contained in the light emitted from the backlight 10 which has been reflected by the reflectance changing section 45 is transmitted through the visible light blocking filters 31 and enters the light sensor elements 30. Similarly, that portion of ultraviolet light contained in the light emitted from the backlight 10 which has been transmitted through the reflectance changing section 45 is absorbed by the ultraviolet light blocking filter (front-side polarizing plate 40a). Meanwhile, that portion of the ultraviolet light contained in the light emitted from the backlight 10 which has been reflected by the reflectance changing section 45 is transmitted through the visible light blocking filters 31 and enters the light sensor elements 30. On the other hand, that portion of visible light contained in the light emitted from the backlight 10 which has been transmitted through the reflectance changing section 45 is emitted out of the liquid crystal display device 100. Meanwhile, that portion of the visible light contained in the light emitted from the backlight 10 which has been reflected by the reflectance changing section 45 is blocked by the visible light blocking filters 31 and does not enter the light sensor elements 30.

That is, only those portions of the infrared and ultraviolet light contained in the light emitted from the backlight 10 which have been reflected by the reflectance changing section 45 enter the light sensor elements 30.

Further, FIG. 1 shows a liquid crystal driving circuit 60 that drives the liquid crystal panel 20 to carry out a display and an area sensor control section 70 for driving the area sensor. FIG. 1 also shows internal components of the area sensor control section 70. It should be noted that the configurations of the liquid crystal driving circuit and area sensor control section of the present embodiment thus applied may be those which have conventionally been publicly known.

As shown in FIG. 1, the area sensor control section 70 includes a timing generating circuit 71, an area sensor driving circuit 72, an area sensor readout circuit 73, a coordinate extracting circuit 74, and an interface circuit 75.

The timing generating circuit 71 generates timing signals for controlling the circuits so that they operate in synchronization with each other.

The area sensor driving circuit 72 supplies a power source for driving the light sensor elements 30.

The area sensor readout circuit 73 receives received-light signals from the light sensor elements 30 that pass therethrough currents of different values depending on the amount of received light, and calculates the amount of received light.

The coordinate extracting circuit 74 calculates, in accordance with the amount of light received by the light sensor elements 30 as calculated by the area sensor readout circuit 73, the coordinates of a finger touching the surface (detector surface 100a) of the liquid crystal panel.

The interface circuit 75 outputs information on the coordinates of the finger as calculated by the coordinate extracting circuit 74 to another control section (e.g., the liquid crystal driving circuit 60, etc.) within the liquid crystal display device 100.

By having such a configuration, the liquid crystal display device 100 allows the light sensor elements 30 formed in the liquid crystal panel 20 to detect the position of an input by capturing as an image a finger or input pen touching the surface (detector surface 100a) of the device.

Moreover, in the liquid crystal display device 100 of the present embodiment, the formation of the reflectance changing section 45 by the laminated structure of the elastic film 50 and the front-side polarizing plate 40a allows the reflectance of light from the backlight 10 to change when a finger, an input pen, or the like makes contact with the detector surface 100a and applies pressure to it. This makes it possible to accurately detect whether or not the finger or input pen is in touch with the panel surface.

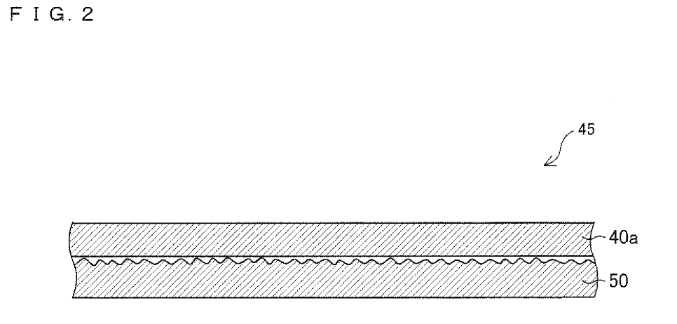

FIG. 2 shows an example of the structure of the reflectance changing section 45 provided in the liquid crystal display device 100. In the reflectance changing section 45 shown in FIG. 2, the front-side polarizing plate 40a (flat-plate transparent substrate) is laminated on the elastic film 50, and the elastic film 50 has a large number of irregularities formed on that surface thereof which is in contact with the front-side polarizing plate 40a. It is preferable that the average interval between the irregularities fall within a range of 3 μm to 2 mm. Further, it is preferable that the average roughness of midlines fall within a range of 5 μm to 50 μm. The “average roughness of midlines” here is the average value of depths of the irregularities and serves as an index of ease with which the elastic film and the front-side polarizing plate (transparent substrate) stick to each other. That is, the smaller the average roughness is (the shallower the irregularities are), the narrower the air passage becomes and the easier it becomes for the elastic film and the transparent substrate to adsorb each other.

The elastic film 50 can be made of any material that has elasticity, but is preferably made of rubber or the like. It is preferable that the elastic film 50 have a transmittance of 90% or higher. Further, it is preferable that the elastic film 50 have a refractive index of 1.3 to 1.6.

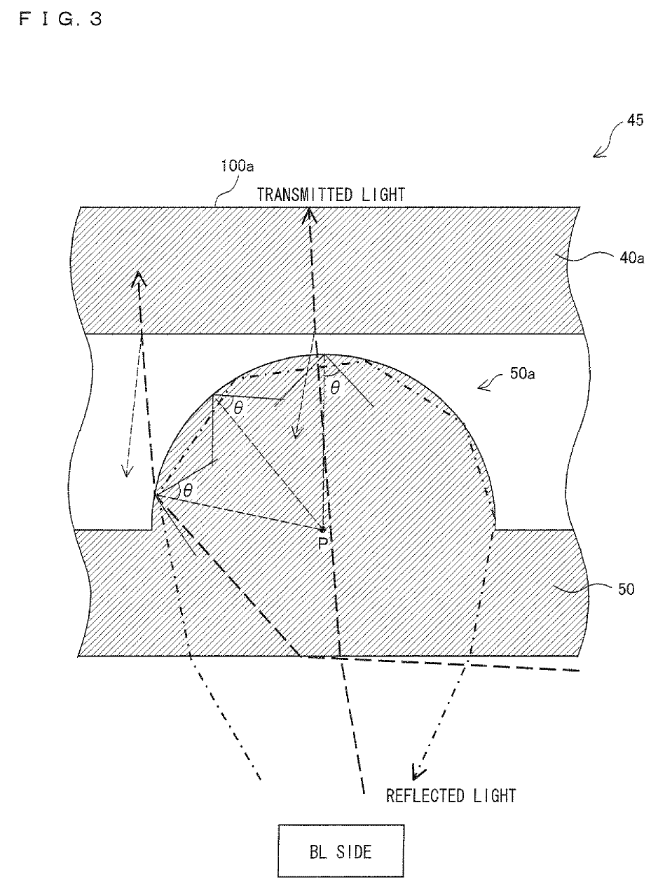

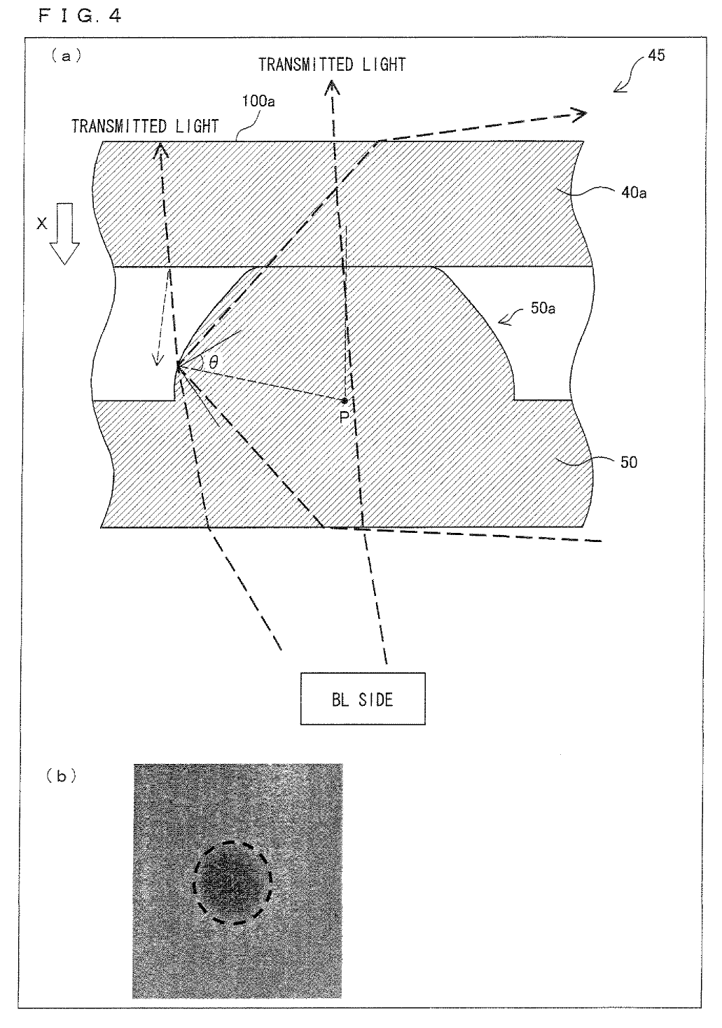

By having such a structure, the reflectance changing section 45 allows the reflectance of light from the backlight 10 to lower when a finger or the like touches the detector surface 100a and applies pressure to it. This point is explained below with reference to FIGS. 3 and 4.

FIG. 3 is an enlarged view of part of the reflectance changing section 45 shown in FIG. 2, with no pressure being applied to the panel surface. Further, (a) of FIG. 4 is an enlarged view of part of the reflectance changing section 45 shown in FIG. 2, with pressure being applied to the panel surface.

As shown in FIG. 3, in the absence of pressure being applied to the detector surface 100a, there is no contact between a raised part 50a (raised part which constitutes the irregularities) formed on that surface of the elastic film 50 which makes contact with the front-side polarizing plate 40a and the front-side polarizing plate 40a. That is, there is an air layer formed between the raised part 50a of the elastic film 50 and the front-side polarizing plate 40a.

In FIG. 3, the dotted or dashed and arrows indicate rays of light that enter the reflectance changing section 45 from behind (i.e., from the backlight 10). It should be noted that the dotted arrows indicate the light paths of rays of light that travel through the elastic film 50 and the dashed arrow indicates the light path of a ray of light reflected within the raised part 50a of the elastic film 50.

It should be noted here that the elastic film 50 is made of a material having a refractive index of n. Further, let it be assumed that P is the spherical center of the substantially hemispherical raised part 50a. With attention focused on an angle of incidence of light based on a normal line drawn from the spherical center P to the surface of the raised part 50a, those rays of light which have entered the surface of the raised part 50a at an angle θ or smaller are transmitted through the surface. Meanwhile, those rays of light which have entered the surface at an angle larger than the angle based on the normal line are reflected by the surface. It should be noted that the angle θ is determined by the refractive index n of the material of which the elastic film 50 is made.

The rays of light which have traveled through the elastic film 50 as indicated by the dotted lines enter the air layer present between the elastic film 50 and the front-side polarizing plate 40a. A ray of light that passes through the air layer is split into reflected light and transmitted light at the boundary between the air layer and the front-side polarizing plate 40a.

Meanwhile, the ray of light which is reflected by the surface of the raised part 50a of the elastic film 50 as indicated by the dashed line is emitted toward the backlight 10, as shown in FIG. 3, while being reflected by the surface of the raised part 50a. That is, of the light emitted from the backlight 10, the ray of light indicated by the dashed line is reflected by the reflectance changing section 45.

In the following, a situation in which a finger or the like touches the detector surface 100a and applies pressure to the reflectance changing section 45 is described with reference to (a) of FIG. 4.

As shown in (a) of FIG. 4, when pressure is applied to the reflectance changing section 45 in the direction of the arrow X, the raised part 50a of the elastic film 50 is compressed to make contact with the surface of the front-side polarizing plate 40a. This causes such a change as below in light path of light from the backlight 10.

At the point of contact between the raised part 50a and the front-side polarizing plate 40a, there is no more air layer, with the result that there is no more light reflected at the boundary between the air layer and the front-side polarizing plate 40a and all the light is transmitted toward the front-side polarizing plate 40a. Further, the ray of light which has entered the surface at an angle larger than the angle θ (which, in FIG. 3, corresponds to the ray of light emitted toward the backlight 10 while being reflected within the raised part 50a) is transmitted at the point of contact between the raised part 50a and the front-side polarizing plate 40a toward the front-side polarizing plate 40a. That is, there is no longer such a light path as indicated by the dashed line in FIG. 3.

Because of such action, application of pressure to the detector surface 100a causes the reflectance of light from the backlight 10 to lower in the reflectance changing section 45.

As described above, the reflectance changing section 45 provided in the liquid crystal display device 100 is structured such that the reflectance of light from the backlight 10 varies between the presence and absence of pressure being applied to the panel surface (detector surface 100a). Specifically, the reflectance changing section 45 is structured such that the reflectance of light from the backlight 10 is lower in the presence of pressure being applied to the detector surface 100a than in the absence of such pressure.

(b) of FIG. 4 shows an image that is detected by the light sensor elements 30 when a finger touches the panel surface. In a region in the detector surface 100a that a finger is in touch with (in the region surrounded by a dotted line in (b) of FIG. 4), the reflectance changing section 45 lowers the reflectance of light from the backlight 10 and allows most of the light to travel through it, thus causing a decrease in amount of light that is detected by the light sensor elements 30. For this reason, as shown in (b) of FIG. 4, the region in the detector surface 100a that the finger is in touch with is detected, as a darker image as compared to other regions.

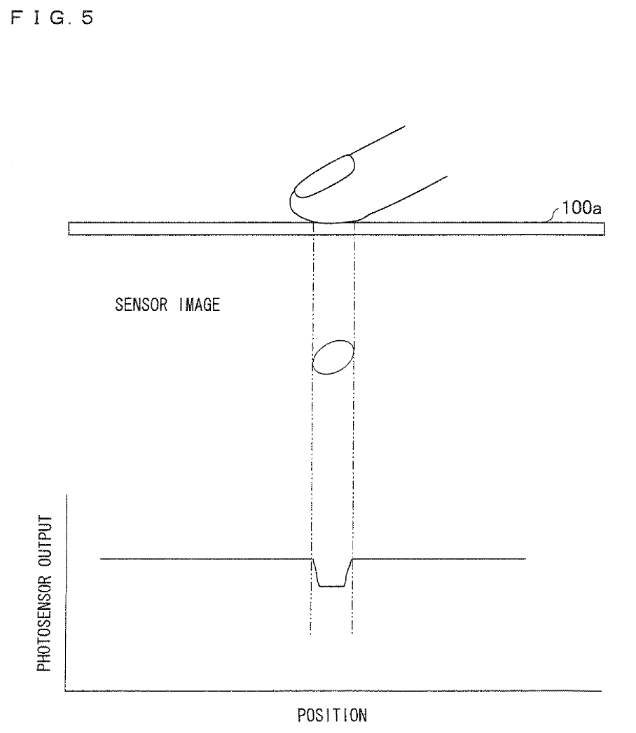

Further, FIG. 5 schematically shows an output from the light sensor elements 30 when a finger touches the panel surface of the liquid crystal display device 100. As shown in the graph of FIG. 5, due to the fact that the reflectance of light from the backlight lowers only at a point of contact with the panel surface, there is a decrease in output from the light sensor elements 30.

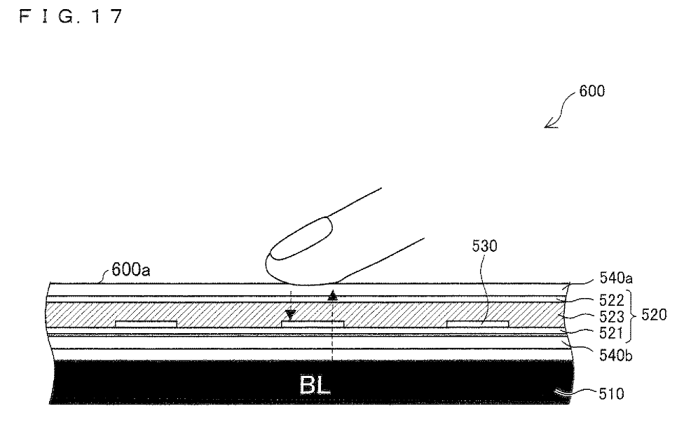

For comparison, the configuration of a conventional touch-panel-integrated liquid crystal device having an area sensor function is described here. FIG. 17 shows the configuration of a conventional touch-panel-integrated liquid crystal device 600.

As shown in FIG. 17, the conventional touch-panel-integrated liquid crystal device 600 (also simply called “liquid crystal device 600”) includes a liquid crystal panel 520 and a backlight 510, provided toward a back surface of the liquid crystal panel 520 (toward that side of the liquid crystal panel 520 which faces the backlight 510), which irradiates the liquid crystal panel with light.

The liquid crystal panel 520 includes: an active matrix substrate 521 having a large number of pixels arrayed in a matrix manner; a counter substrate 522 disposed opposite the active matrix substrate 521; and a liquid crystal layer 523, sandwiched between the two substrates, which serves as a display medium.

Further, on outer sides of the liquid crystal panel 520, there are provided a front-side polarizing plate 540a and a back-side polarizing plate 540b, respectively, with the liquid crystal panel 520 sandwiched therebetween.

The active matrix substrate 521 is provided with TFTs (not illustrated) serving as switching elements for driving the pixels, an alignment film (not illustrated), light sensor elements 530, etc.

When a finger or input pen makes contact with the detector surface 600a, the liquid crystal display device 600 uses light from the backlight 510 as a light source to detect the position of the input by recognizing the finger or input pen as an image. That is, the light sensor elements 530 use light emitted from the backlight 510 and transmitted through the liquid crystal panel 520 to detect light that is a reflection of the transmitted light from the object on the detector surface 600a. In this way, the liquid crystal display device 600 detects the position of the finger or input pen as image data.

It should be noted here that a comparison between the configuration of the liquid crystal display device 100 of the present embodiment and the configuration of the conventional liquid crystal display device 600 shows that the conventional liquid crystal display device 600 differ in that it is not provided with a reflectance changing section, visible light blocking filters, or an infrared light blocking filter. That is, the liquid crystal display device 600 only detects an object present on the detector surface 600a simply as image data.

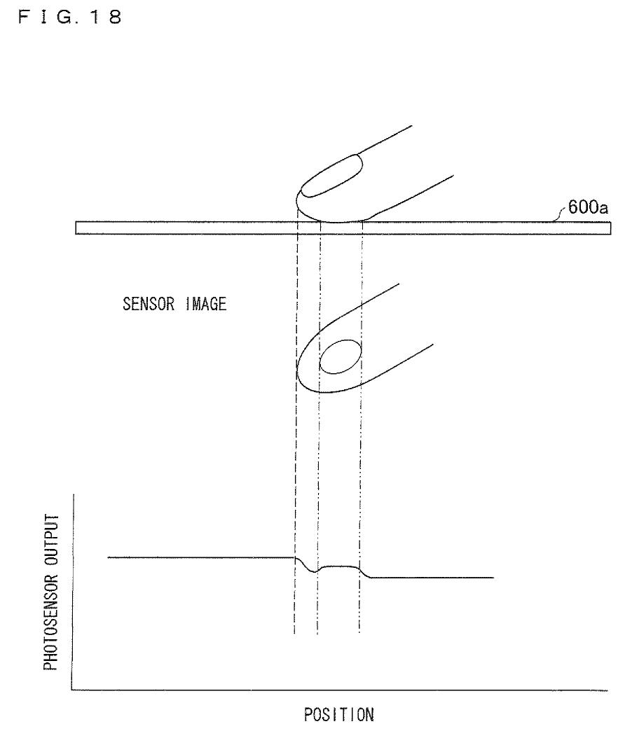

FIG. 18 schematically shows an output from the light sensor elements 530 when a finger touches the panel surface of the liquid crystal display device 600. As shown in the graph of FIG. 18, in a region in the detector surface 600a on which a finger is present, the light sensor elements 530 tend to be lower in output than in a region where a finger is absent; however, the difference in output is small. Further, due to the absence of a reflectance changing section, it is impossible to clearly determine whether a finger or the like is in touch with the detector surface 600a. For this reason, the light sensor elements 530 cannot be said to be sufficient in detection accuracy to exactly specify the position of an input produced by a finger, an input pen, or the like.

Further, in such a case as in the liquid crystal display device 600 where a light-emitting section, such as the backlight, provided toward back surfaces of the light sensor elements (toward those surfaces of the light sensor element which face the backlight 510) serves as a light source and an image of the panel surface is detected by light reflected from an object on the panel surface, and in a case where the display device displays a dark image such as a black display, there is a decrease in amount of reflected light. This undesirably causes a significant decrease in detection sensitivity of the light sensor.

As for the liquid crystal display device 100 of the present embodiment, on the other hand, in a region in the panel surface (detector surface 100a) that a finger or the like is not in touch with, most of the light from the backlight 10 is reflected within the reflectance changing section 45 as indicated by arrows B in FIG. 1. Meanwhile, in a region in the panel surface (detector surface 100a) that a finger or the like is in touch with, most of the light from the backlight 10 is transmitted as indicated by arrows A in FIG. 1, with the result that the reflectance lowers. This makes it possible to more clearly discriminate between the presence and absence of a finger, an input pen, or the like touching the panel surface, as compared to the conventional area-sensor-equipped liquid crystal display device.

Furthermore, since the reflectance changing section 45 is formed by laminating the front-side polarizing plate 40a on the elastic film 50, the amount of light that travels through the elastic film 50 does not depend on the state of a display being carried out by the liquid crystal panel 20 (i.e., whether the liquid crystal panel 20 is displaying a bright image or a dark image). For this reason, the light sensor elements 30 can be made always constant in detection performance regardless of the state of a display being carried out by the liquid crystal panel 20.

Further, since, in the present embodiment, the reflectance changing section 45 is configured by laminating the flat-plate front-side polarizing plate 40a on the elastic film 50 having an irregular surface, the reflectance of light in the reflectance changing section 45 can be further heightened in the absence of pressure being applied to the detector surface 100a and further lowered in the presence of pressure being applied to the detector surface 100a. This makes it possible to more clearly detect whether a finger or the like is in touch with the detector surface 100a.

Furthermore, formation of irregularities on that surface of the elastic film 50 which makes contact with the front-side polarizing plate 40a allows an air layer to be partially formed when a finger, an input pen, or the like applies pressure to the detector surface 100a and brings the elastic film 50 and the front-side polarizing plate 40a into contact with each other; therefore, the ease with which the elastic film and the front-side polarizing plate 40a become separated from each other when released from pressure can be improved. This makes it possible to prevent the elastic film 50 and the front-side polarizing plate 40a from keeping sticking to each other instead of becoming separated again from each other after completion of an input to the area sensor.

As described in the present embodiment, the reflectance changing section is designed to lower the reflectance of light from the backlight (light-emitting section) when under pressure. However, the present invention is not limited to this. The reflectance changing section may be designed to raise the reflectance of light when under pressure.

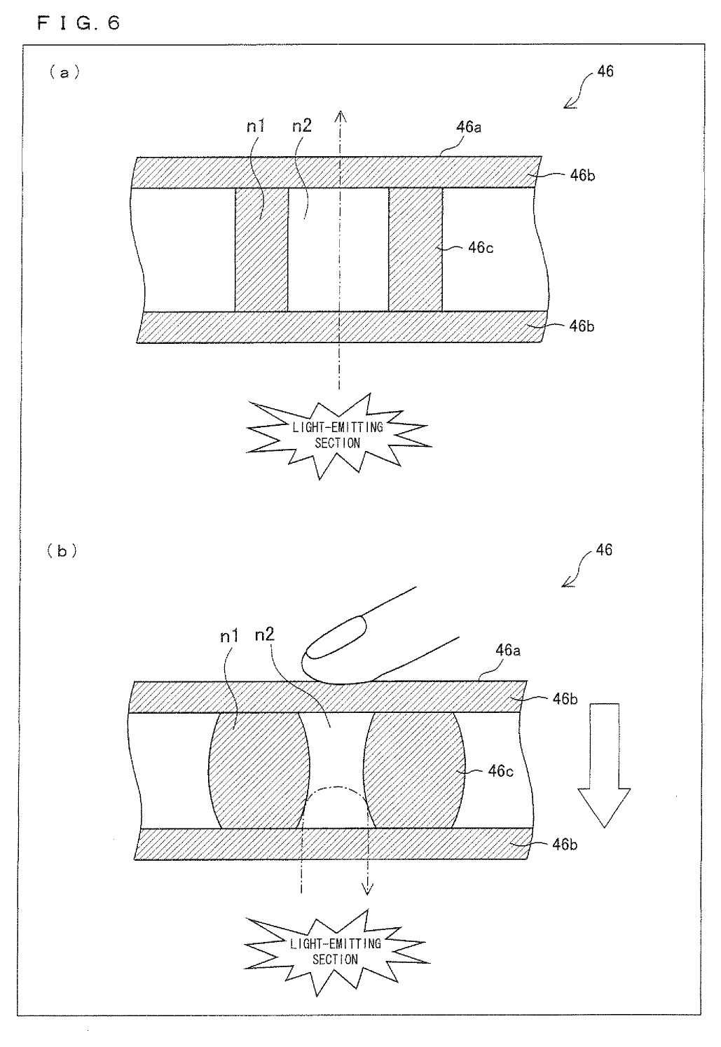

(a) and (b) of FIG. 6 show an example of the structure of a reflectance changing section designed to raise the reflectance of light from a light-emitting section when under pressure. (a) of FIG. 6 shows a cross-sectional structure of a reflectance changing section 46 with no pressure being applied to a detector surface 46a, and (b) of FIG. 6 shows a cross-sectional structure of the reflectance changing section 46 with pressure being applied to the detector surface 46a.

As shown in (a) of FIG. 6, the reflectance changing section 46 is shaped such that with no pressure being applied to the detector surface 46a, two flat plates 46b made of an elastic body such as rubber are connected to each other through a plurality of columnar bodies 46c. If, for example, n1 is the refractive index of the elastic body and n2 is the refractive index of the air layer, then it looks as though an alternating array of air layers and columnar bodies 46c different in refractive index from each other were sandwiched between the two flat plates 46b.

The reflectance changing section 46 has such a structure; therefore, in the absence of pressure being applied to the detector surface 46a, a ray of light (indicated by a dashed line in (a) of FIG. 6) emitted from the light-emitting section, such as a backlight, provided toward a back surface of the reflectance changing section 46 (toward that surface of the reflectance changing section 46 which faces away from the detector surface 46a) travels through the reflectance changing section 46 (see (a) of FIG. 6).

Meanwhile, when a finger or the like makes contact with the detector surface 46a and applies pressure to it, the columnar bodies 46c are compressed and deformed in the direction of an arrow as shown in (b) of FIG. 6. This causes a ray of light (indicated by a dashed line in (b) of FIG. 6) emitted from the light-emitting section, such as a backlight, to be reflected by the reflectance changing section 46.

A liquid crystal display device of the present invention may be provided with a reflectance changing section that raises the reflectance of light from a light-emitting section by applying pressure to such a detector surface.

Further although each of the reflectance changing sections described as examples in the present embodiment has a large number of irregularities formed on that surface of the elastic film 50 which is in contact with the front-side polarizing plate 40a, the present invention is not limited to such a structure. That is, a reflectance changing section that has a large number of irregularities formed on that surface of the elastic film 50 which faces away from the surface of contact with the front-side polarizing plate 40a is also encompassed in the present invention. Such a structure makes it possible to achieve a reflectance changing section designed to lower reflectance when under pressure. However, in this structure, the variation width of reflectance between the presence and absence of pressure being applied to the detector surface is narrower than in the reflectance changing section 45 of the present embodiment.

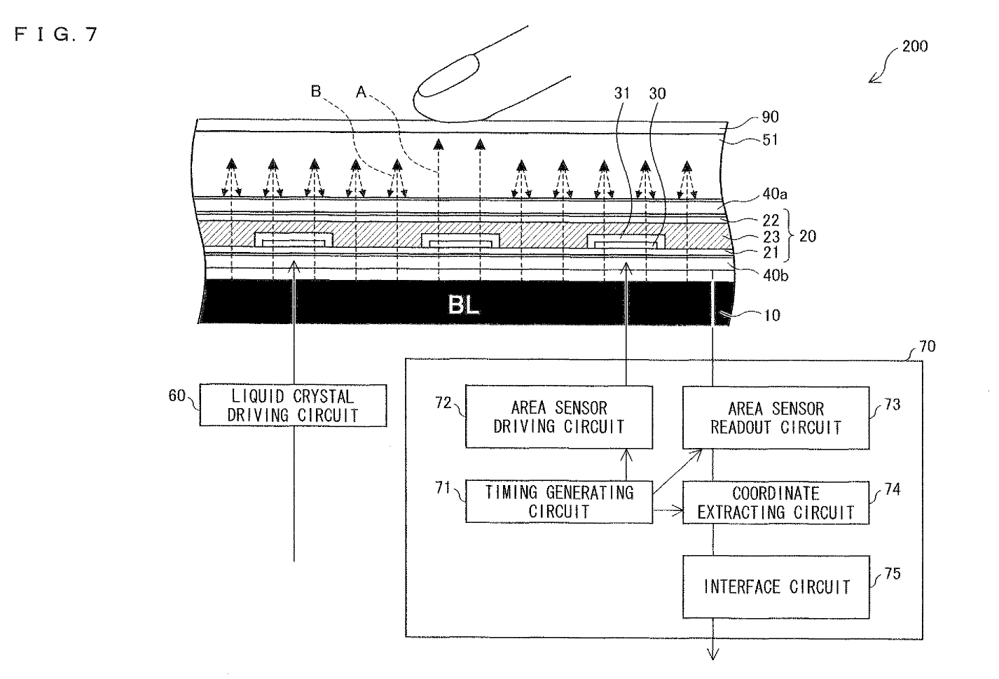

Further, although the embodiment has been described above by taking as an example a case where the elastic film 50 and the front-side polarizing plate 40a forms a laminated structure that serves as a reflectance changing section, the present invention is not limited to such a configuration. FIG. 7 shows another example configuration of the present invention.

FIG. 7 shows a liquid crystal display device 200 having a reflectance changing section 51 formed above the front-side polarizing plate 40a. Although not illustrated specifically, the reflectance changing section 51 is structured such that a flat-plate transparent substrate is laminated on the elastic film 50 as shown in FIG. 2. Examples of materials for the transparent substrate include acrylic, diamond, quartz, etc. The liquid crystal display device 200 shown in FIG. 7 is identical in configuration to the liquid crystal display device 100 except for this component and, therefore, is not described below.

According to such a configuration, in a region in the surface of the liquid crystal display device 200 that a finger or the like is not in touch with, most of the light from the backlight 10 is reflected within the reflectance changing section 51 as indicated by arrows B in FIG. 7. Meanwhile, in a region in the surface of the liquid crystal display device 200 that a finger or the like is in touch with, most of the light from the backlight 10 is transmitted as indicated by arrows A in FIG. 7, with the result that the reflectance lowers. This makes it possible to more accurately detect the presence or absence of a touch with the panel surface, as compared to the conventional area-sensor-equipped liquid crystal display device.

It should be noted, however, that in order to achieve an area sensor that is high in detection performance independently of the state of a display being carried out by a liquid crystal device (even when the display is dark), it is preferable that a reflectance changing section be disposed below the front-side polarizing plate 40a.

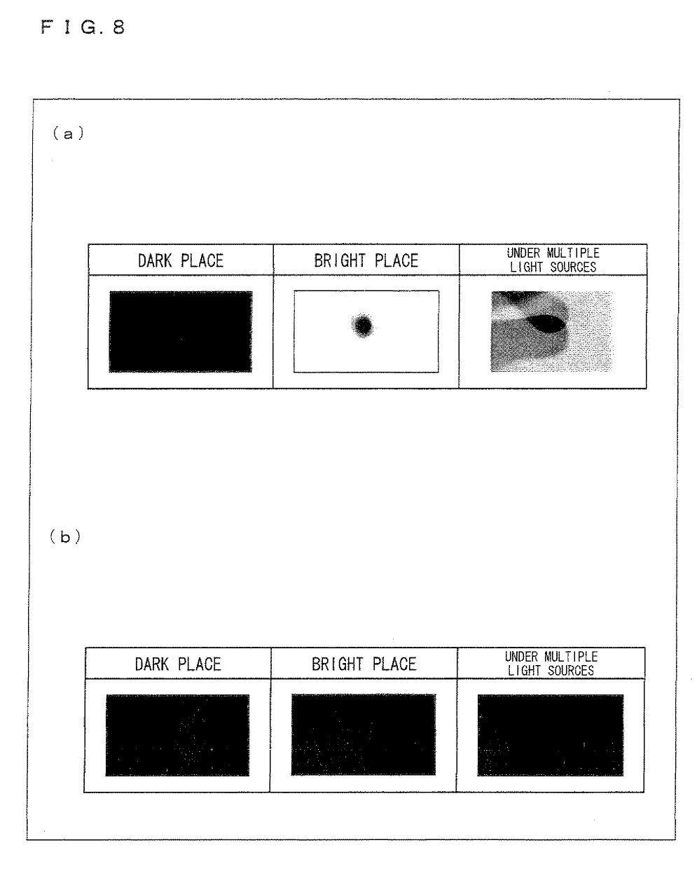

(a) of FIG. 8 shows images that are detected by light sensor elements in a conventional area-sensor-equipped liquid crystal display device, and (b) of FIG. 8 shows images that are detected by light sensor elements in a liquid crystal display device of the present invention.

See the images titled “BRIGHT PLACE” and “UNDER MULTIPLE LIGHT SOURCES”, respectively, in (a) of FIG. 8. In a region in the detector surface 100a that a finger is in touch with (indicated in black in each image), the reflectance changing section 45 lowers the reflectance of infrared light from the backlight 10 and allows most of the light to travel through it, thus causing a decrease in amount of light that is detected by the light sensor elements 30. For this reason, as seen in the images titled “BRIGHT PLACE” and “UNDER MULTIPLE LIGHT SOURCES”, respectively, in (a) of FIG. 8, the region in the detector surface 100a that the finger is in touch with is detected as a darker image than other regions. See also the image titled “DARK PLACE” in (a) of FIG. 8. Since, in a dark place, there is no influence from outside light, the image detected is dark as a whole. On the other hand, as shown in (b) of FIG. 8, the liquid crystal display device 100 of the present invention is free of influence from outside light, whether in a bright place or under multiple light sources, as in the case of a dark place, and is always constant in sensor output, thus achieving a simpler coordinate detection algorithm.

### Embodiment 2

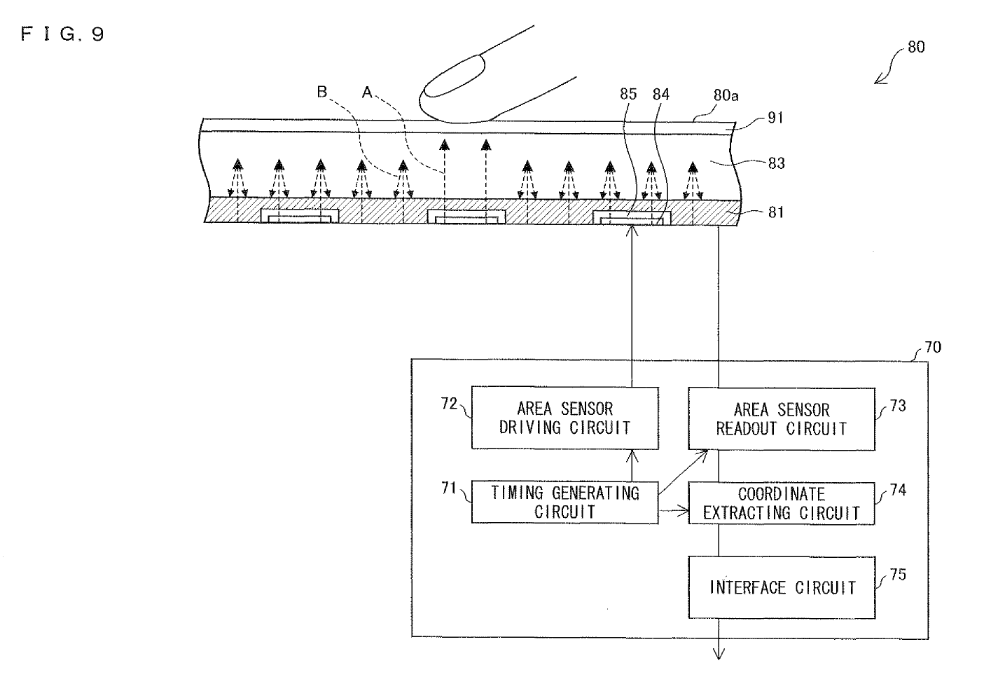

A second embodiment of the present invention is described below with reference to FIG. 9. It should be noted that the present invention is not limited to this.

In Embodiment 1 above, a touch-panel-integrated liquid crystal display device having an area sensor function (specifically, a touch panel function) has been described. In Embodiment 2, an area sensor not integrated with a display device is described.

FIG. 9 shows an area sensor 80 having a touch panel function of detecting the position of an input through detection of an image on a detector surface 80a by a plurality of light sensor elements 84 provided on a substrate 81.

As shown in FIG. 9, the area sensor 80 includes the substrate 81 (position detecting section) having the plurality of light sensor elements 84. The area sensor 80 may further include a light-emitting section (not illustrated), provided toward a back surface of the substrate 81 (toward that surface of the substrate 81 which faces away from the detector surface 80a), which irradiates the substrate with light. Each of the light sensor elements 84 is formed by a photodiode or a phototransistor and detects the amount of received light by passing therethrough a current corresponding to the intensity of the received light. A method for forming such a light sensor element can be carried out according to a conventionally publicly known method for manufacturing an area sensor.

Further, the area sensor 80 of the present embodiment has visible light blocking filters 85, provided on those respective sides of the light sensor elements 84 which face the detector surface 80a and between the substrate 81 (surface of the substrate 81 that faces away from the detector surface 80a) and a reflectance changing section 83, which does not transmit visible light. Furthermore, the area sensor 80 of the present embodiment has an infrared and ultraviolet light blocking filter 91, provided on that side of the reflectance changing section 83 which faces the detector surface 80a, which transmits neither infrared or ultraviolet light. The workings of the visible light blocking filters 85 and of the infrared and ultraviolet light blocking filter 91 and the types of light that enter the light sensor elements 84 are not described in detail here, because the arrangements (workings of the visible light blocking filter 31, of the infrared light blocking filter 90, and of the ultraviolet light blocking filter [front-side polarizing plate 40a] and the types of light that enter the light sensor elements 30) of Embodiment 1 above can be applied here.

Further, the area sensor 80 is provided with an area sensor control section 70 for driving the area sensor. As shown in FIG. 9, the area sensor control section 70 includes a timing generating circuit 71, an area sensor driving circuit 72, an area sensor readout circuit 73, a coordinate extracting circuit 74, and an interface circuit 75. The configuration of the area sensor control section is not described in detail here, because the configuration of Embodiment 1 above or the conventionally publicly known configuration can be applied here.

By having such a configuration, the area sensor 80 allows the light sensor elements 84 formed on the substrate 81 to detect the position of an input by capturing as an image a finger or input pen touching the detector surface 80a.

Moreover, the area sensor 80 of the present embodiment has the reflectance changing section 83 formed on the substrate 81. The structure of the reflectance changing section 83 is not described in detail here, because the structure of any reflectance changing section described in Embodiment 1 can be applied here.

The foregoing configuration allows the reflectance of light to change when a finger, an input pen, or the like makes contact with the detector surface 80a and applies pressure to it. This makes it possible to accurately detect whether or not the finger or input pen is in touch with the detector surface 80a.

### Embodiment 3

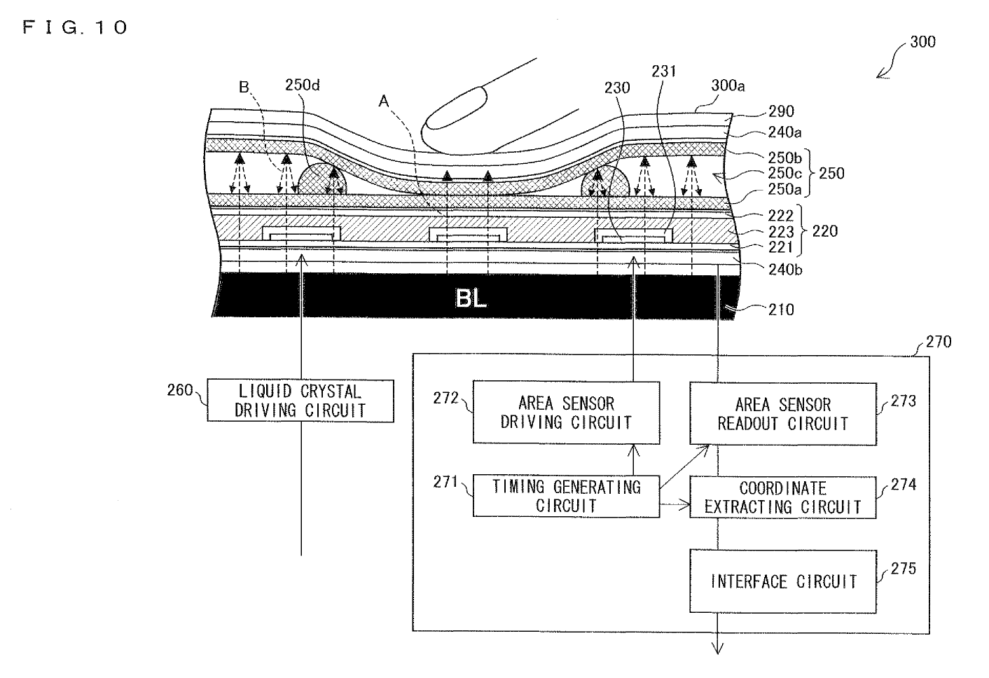

A third embodiment of the present invention is described below with reference to FIGS. 10 through 14. It should be noted that the present invention is not limited to this. The present embodiment is identical to Embodiment 1 except for those components which are described in the present embodiment and, therefore, is described as needed with reference to the drawings of Embodiment 1.

The present embodiment describes a touch-panel-integrated liquid crystal display device having an area sensor function (specifically, a touch panel function).

The configuration of a touch-panel-integrated liquid crystal display device of the present embodiment is described with reference to FIG. 10. A touch-panel-integrated liquid crystal display device 300 shown in FIG. 10 (also simply called “liquid crystal display device 300”) has a touch panel function of detecting the position of an input through detection of an image on a surface of a display panel by a light sensor element provided in each pixel.

As shown in FIG. 10, the touch-panel-integrated liquid crystal display device 300 of the present embodiment includes: a liquid crystal panel 220 (position detecting section); and a backlight 210 (light-emitting section), provided toward a back surface of the liquid crystal panel 220 (toward that side of the liquid crystal panel 220 which faces the backlight 210), which irradiates the liquid crystal panel with light. It should be noted that although the touch-panel-integrated liquid crystal display device 300 of the present embodiment includes the backlight 210, it is encompassed in the scope of the present invention even if it does not include the backlight 210, so long as the liquid crystal panel 220 can be irradiated with light containing at least infrared light or ultraviolet light from behind. It should be noted that the backlight 210 emits light at least containing infrared light or ultraviolet light.

The liquid crystal panel 220 includes: an active matrix substrate 221 having a large number of pixels arrayed in a matrix manner; a counter substrate 222 disposed opposite the active matrix substrate 221; and a liquid crystal layer 223, sandwiched between the two substrates, which serves as a display medium. It should be noted that the liquid crystal panel 220 has the same functions as does the liquid crystal panel 20 described above in Embodiment 1.

Further, on outer sides of the liquid crystal panel 220, there are provided a front-side polarizing plate 240a (polarizing plate provided toward an image display surface) and a back-side polarizing plate 240b, respectively, with the liquid crystal panel 220 sandwiched therebetween. It should be noted that the polarizing plates 204a and 240b have the same functions as do the polarizing plates 40a and 40b described above in Embodiment 1, respectively.

Provided between the front-side polarizing plate 240a and the liquid crystal panel 220 is a reflectance changing section 250 that effects a change in reflectance of light from the backlight 210 when pressure is applied to the surface of the device (detector surface 300a of the touch panel). It should be noted that the detector surface 300a is also called “panel surface”.

The active matrix substrate 221 is provided with TFTs (not illustrated) serving as switching elements for driving the pixels, an alignment film (not illustrated), light sensor elements 230, etc.

Further, the counter substrate 222 has the same structure as does the counter substrate 22 described above in Embodiment 1.

As mentioned above, the touch-panel-integrated liquid crystal display device 300 of the present embodiment has a light sensor element 230 provided in each pixel region, whereby an area sensor is achieved. It should be noted that the light sensor elements 230 have the same functions as do the light sensor elements 30 described above in Embodiment 1.

Further, although not shown in FIG. 10, the liquid crystal display device of the present invention may have front-side and back-side phase plates so provided on the outer sides of the active matrix substrate 221 and the counter substrate 222, respectively, as to serve as optical compensation elements.

Further, the touch-panel-integrated liquid crystal display device 300 of the present embodiment has visible light blocking filters 231, provided on those respective sides of the light sensor elements 230 which face the detector surface 300a and between the liquid crystal panel 220 (active matrix substrate 221 of the liquid crystal panel 220) and the reflectance changing section 250, which does not transmit visible light. Furthermore, the touch-panel-integrated liquid crystal display device 300 of the present embodiment has an infrared light blocking filter 290, provided on that side of the reflectance changing section 250 which faces the detector surface 300a, which does not transmit infrared light. It should be noted that in the touch-panel-integrated liquid crystal display device 300 of the present embodiment, the front-side polarizing plate 240a works as an ultraviolet light blocking filter that does not transmit ultraviolet light.

It should be noted here that although, in the touch-panel-integrated liquid crystal display device 300 of the present embodiment, the infrared light blocking filter 290 is located closer to the detector surface 300a than the ultraviolet light blocking filter (front-side polarizing plate 240a) is, this does not imply any particular limitation. Even if the ultraviolet light blocking filter (front-side polarizing plate 240a) is located closer to the detector surface 300a than the infrared light blocking filter 290 is, it is encompassed in the scope of the present invention.

The workings of the visible light blocking filters 231, of the infrared light blocking filter 290, and of the ultraviolet light blocking filter (front-side polarizing plate 240a) and the types of light that enter the light sensor elements 230 are not described in detail here, because the arrangements (workings of the visible light blocking filter 31, of the infrared light blocking filter 90, and of the ultraviolet light blocking filter [front-side polarizing plate 40a] and the types of light that enter the light sensor elements 30) of Embodiment 1 above can be applied here.

Further, FIG. 10 shows a liquid crystal driving circuit 260 that drives the liquid crystal panel 220 to carry out a display and an area sensor control section 270 for driving the area sensor. FIG. 10 also shows internal components of the area sensor control section 270. It should be noted that the configurations of the liquid crystal driving circuit and area sensor control section of the present embodiment thus applied may be those which have conventionally been publicly known.

As shown in FIG. 10, the area sensor control section 270 includes a timing generating circuit 271, an area sensor driving circuit 272, an area sensor readout circuit 273, a coordinate extracting circuit 274, and an interface circuit 275. It should be noted that the timing generating circuit 271, the area sensor driving circuit 272, the area sensor readout circuit 273, the coordinate extracting circuit 274, and the interface circuit 275 have the same functions as do their counterparts (the timing generating circuit 71, the area sensor driving circuit 72, the area sensor readout circuit 73, the coordinate extracting circuit 74, and the interface circuit 75) described above in Embodiment 1, respectively.

By having such a configuration, the liquid crystal display device 300 allows the light sensor elements 230 formed in the liquid crystal panel 220 to detect the position of an input by capturing as an image a finger or input pen touching the surface (detector surface 300a) of the device.

Moreover, in the liquid crystal display device 300 of the present embodiment, the provision of the reflectance changing section 250 allows the reflectance of light from the backlight 210 to lower when a finger, an input pen, or the like makes contact with the detector surface 200a and applies pressure to it. This makes it possible to accurately detect whether or not the finger or input pen is in touch with the panel surface.

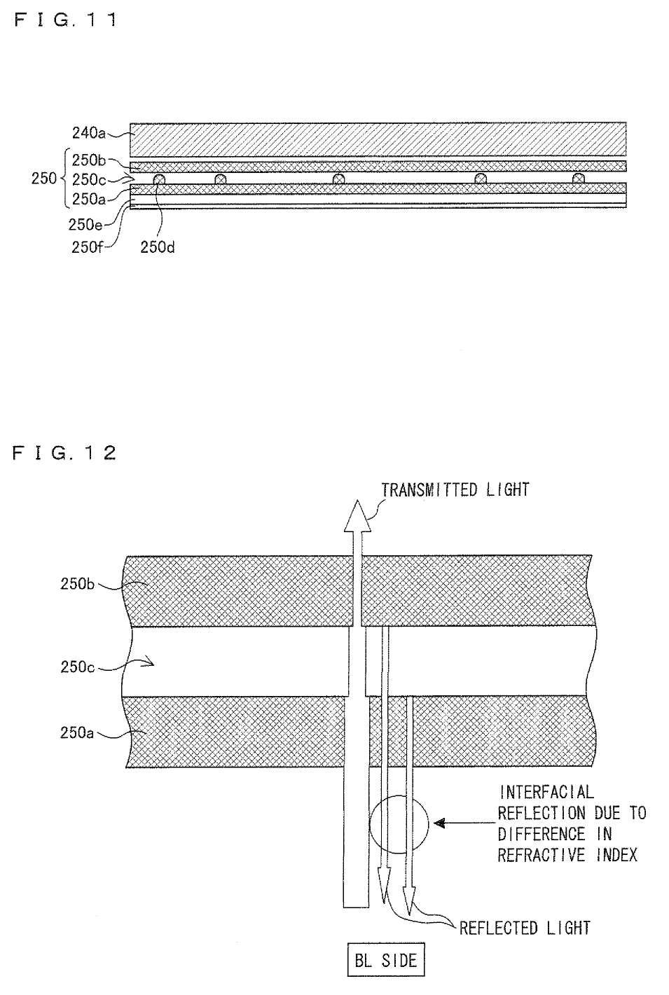

FIG. 11 shows the structure of the reflectance changing section 250 more specifically. It should be noted that FIG. 11 also shows the front-side polarizing plate 240a.

As shown in FIGS. 10 and 11, the reflectance changing section 250 is constituted by two flat-plate elastic films 250a and 250b and an air layer 250c formed therebetween. It should be noted that the air layer 250c is formed with no pressure being applied to the detector surface 300a. That is, as shown in FIG. 10, in a portion of the detector surface 300a that has been pressed by a finger or the like, the upper elastic film 250b is pushed toward the lower elastic film 250a, and their respective surfaces makes contact with each other so that there is no more air layer 250c thereat.

Further, the reflectance changing section 250 of the present embodiment has projections (distance maintaining parts) 250d provided on the lower elastic film 250a so that the air layer 250c is formed. This makes it possible to surely form the air layer 250c between the two elastic films 250a and 250b with no pressure being applied to the detector surface 300a. It should be noted that although the reflectance changing section described as an example in the present embodiment has projections 250d formed on the lower elastic film 250a, the present invention is not limited to such a structure. It is possible to form projections on the upper elastic film 250b or on both of the elastic films 250a and 250b.

Furthermore, as shown in FIG. 11, the reflectance changing section 250 has a support film 250e (support) provided on that side of the lower elastic film 250a which faces the liquid crystal panel 220. The support film 250e, made of a transparent film that is less stretchable than the elastic films 250a and 250b, supports the elastic films 250a and 250b. The provision of the support film 250e makes the reflectance changing section 250 more stable in shape than in a case where the reflectance changing section 250 is formed solely by the elastic films 250a and 250b that are soft and therefore instable in shape, thus making it easy to handle the reflectance changing section 250. This makes the reflectance changing section 250 unlikely to be displaced when it is placed on the liquid crystal panel 220.

Further, as shown in FIG. 11, the reflectance changing section 250 has a layer of glue 250f formed on that side of the support film 250e which faces the liquid crystal panel 220, and this glue is used for joining the reflectance changing section 250 to the liquid crystal panel 220 (not illustrated in FIG. 11).

The elastic films 250a and 250b can each be made of any material that has elasticity, but is preferably made of silicon rubber or the like. It is preferable that the elastic films 250a and 250b each have a transmittance of 90% or higher. Further, it is preferable that the elastic films 250a and 250b each have a refractive index of 1.4 to 1.6. It should be noted that the elastic films 250a and 250b may be made of the same material or different materials.

It should be noted, however, that when the elastic films 250a and 250b are equal in refractive index to each other, contact between the elastic films 250a and 250b allows all light to pass through the reflectance changing section 250. For this reason, it is preferable that the elastic films 250a and 250b be equal in value of refractive index to each other. This makes it possible to more surely detect whether a finger or input pen is in touch with the panel surface.

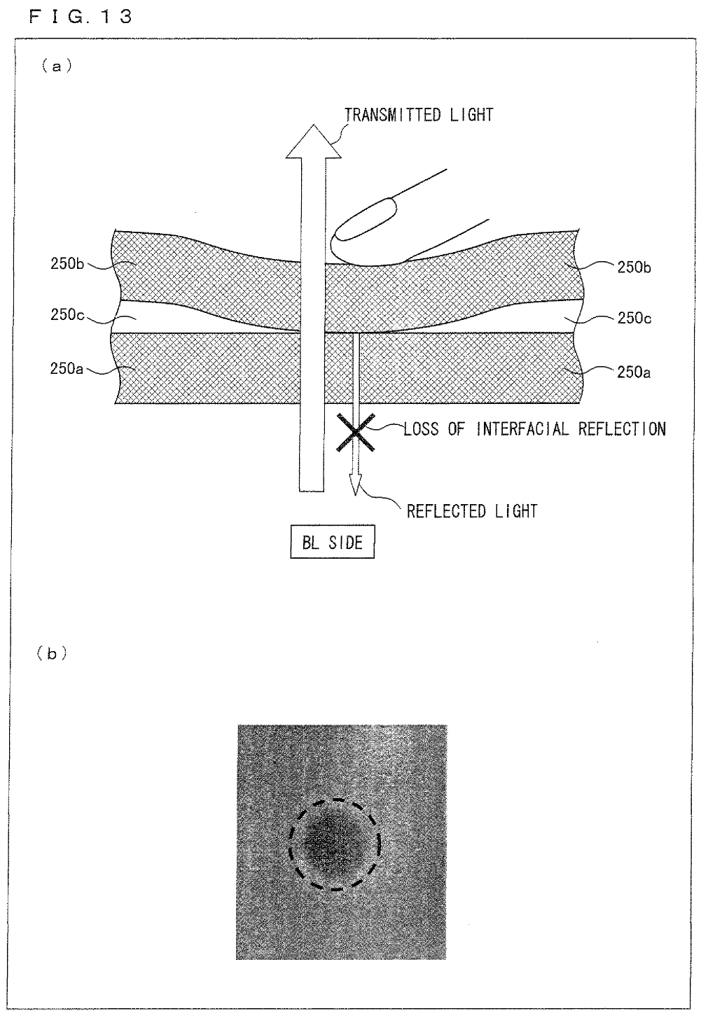

By having such a structure, the reflectance changing section 250 allows the reflectance of light from the backlight 210 to lower when a finger or the like touches the detector surface 300a and applies pressure to it. This point is explained below with reference to FIGS. 12 and 13.

FIG. 12 is an enlarged view of part of the reflectance changing section 250 shown in FIG. 11, with no pressure being applied to the panel surface. Further, (a) of FIG. 13 is an enlarged view of part of the reflectance changing section 250 shown in FIG. 11, with pressure being applied to the panel surface.

As shown in FIG. 12, in the absence of pressure being applied to the detector surface 300a, there is no contact between the inner surface of the upper elastic film 250b (which is closer to the front-side polarizing plate 240a) and the inner surface of the lower elastic film 250a (which is closer to the liquid crystal panel 220). That is, there is an air layer 250c formed between the elastic films 250a and 250b.

FIG. 12 shows a ray of light (transmitted light) that enters the reflectance changing section 250 from behind (from the backlight 210) and travels through the reflectance changing section 250 and rays of light (reflected light) that are reflected by interfaces within the reflectance changing section 250.

Since each of the elastic films 250a and 250b is made of a material having a refractive index of n, which is different from the refractive index of air, there appear two interfaces of different refractive indices between the lower elastic film 250a and the air layer 250c and between the air layer 250c and the upper elastic film 250b, respectively, within the reflectance changing section 250 in the absence of pressure being applied to the detector surface 300a. At these two interfaces, as shown in FIG. 12, part of the light emitted from the backlight 210 is reflected. For this reason, the amount of transmitted light decreases every time it passes through the interfaces.

Therefore, in the absence of pressure being applied to the detector surface 300a, light emitted from the backlight 210 is split into light that travels through the reflectance changing section 250 and light that is reflected within the reflectance changing section 250.

In the following, a situation in which a finger or the like touches the detector surface 300a and applies pressure to the reflectance changing section 250 is described with reference to (a) of FIG. 13.

As shown in (a) of FIG. 13, when pressure is applied to the reflectance changing section 250 in the direction of the arrow X, the upper elastic film 250b and the projections 250d (not illustrated in (a) of FIG. 13) are compressed so that the upper elastic film 250b makes contact with the lower elastic film 250a in the area pressed. This causes such a change as below in light path of light from the backlight 210.

At the point of contact between the elastic films 250a and 250b, there is no more air layer 250c, with the result that there is neither light reflected at the boundary surface between the elastic film 250a and the air layer 250c nor light reflected at the boundary surface between the air layer 250c and the elastic film 250b any more. This causes interfacial reflection to occur only at the boundary surface between the elastic films 250a and 250b, thus causing a sharp drop in amount of reflected light.

Furthermore, when the elastic films 250a and 250b are equal in refractive index to each other, all the light travels through the reflectance changing section 250 and enters the front-side polarizing plate 240a.

Because of such action, application of pressure to the detector surface 300a causes the reflectance of light from the backlight 210 to lower in the reflectance changing section 250.

As described above, the reflectance changing section 250 provided in the liquid crystal display device 300 is configured such that the reflectance of light from the backlight 210 varies between the presence and absence of pressure being applied to the panel surface (detector surface 300a). Specifically, the reflectance changing section 250 is configured such that the reflectance of light from the backlight 210 is lower in the presence of pressure being applied to the detector surface 300a than in the absence of such pressure.

(b) of FIG. 13 shows an image that is detected by the light sensor elements 230 when a finger touches the panel surface. In a region in the detector surface 300a that a finger is in touch with (in the region surrounded by a dotted line in (b) of FIG. 13), the reflectance changing section 250 lowers the reflectance of light from the backlight 210 and allows most of the light to travel through it, thus causing a decrease in amount of light that is detected by the light sensor elements 230. For this reason, as shown in (b) of FIG. 13, the region in the detector surface 2100a that the finger is in touch with is detected as a darker image as compared to other regions.

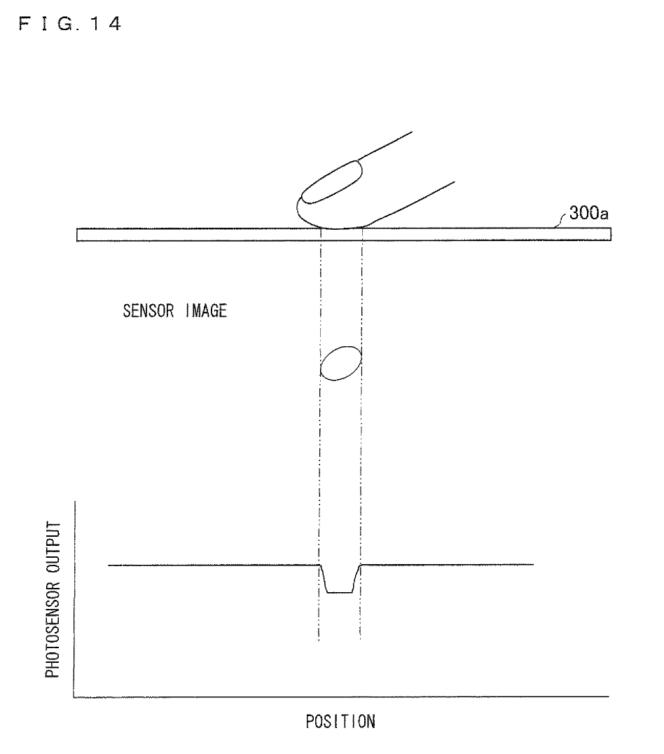

Further, FIG. 14 schematically shows an output from the light sensor elements 230 when a finger touches the panel surface of the liquid crystal display device 300. As shown in the graph of FIG. 14, due to the fact that the reflectance of light from the backlight lowers only at a point of contact with the panel surface, there is a decrease in output from the light sensor elements 230.

As for the liquid crystal display device 300 of the present embodiment, in a region in the panel surface (detector surface 300a) that a finger or the like is not in touch with, most of the light from the backlight 210 is reflected within the reflectance changing section 250 as indicated by arrows B in FIG. 10. Meanwhile, in a region in the panel surface (detector surface 300a) that a finger or the like is in touch with, most of the light from the backlight 210 is transmitted as indicated by arrows A in FIG. 10, with the result that the reflectance lowers. This makes it possible to more clearly discriminate between the presence and absence of a finger, an input pen, or the like touching the panel surface, as compared to the conventional area-sensor-equipped liquid crystal display device.

Further, since the reflectance changing section 250 is constituted by two elastic films having flat shapes except for the projections 250d, there are few factors of light scattering. This makes it possible to suppress deterioration in display quality of the liquid crystal panel 220 that is caused by providing the reflectance changing section 250.

Furthermore, since the reflectance changing section 250 is disposed closer to the inside (i.e., closer to the liquid crystal panel 220) than the front-side polarizing plate 240a is, the amount of light that travels through the reflectance changing section 250 does not depend on the state of a display being carried out by the liquid crystal panel 220 (i.e., whether the liquid crystal panel 220 is displaying a bright image or a dark image). For this reason, the light sensor elements 230 can be made always constant in detection performance regardless of the state of a display being carried out by the liquid crystal panel 220.

Further, the reflectance changing section 250 has projections 250d (distance maintaining parts) formed integrally with the elastic film 250a so that the two elastic films (elastic films 250a and 250b) are placed at a given distance from each other with no pressure being applied to the detector surface 300a. This makes it possible to surely form the air layer 250c between the two elastic films 250a and 250b with no pressure being applied to the detector surface 300a.

It should be noted that in order not to impair the display quality of the liquid crystal panel 220, it is preferable that each of the projections 250d be sized to have a maximum cross-sectional diameter of 15 μm or smaller.

Further, if the plurality of projections 250d are disposed regularly, they may interfere with the pixels of the liquid crystal panel 220 to cause moiré and therefore impair display quality. For this reason, it is preferable that the plurality of projections 250d be disposed randomly. Further, it is preferable that the projections 250d be disposed at such a density that HAZE does not exceed 20% (i.e., at a density of 1000 pieces/mm²). Disposition of the projections 250d at such a density makes it possible to suppress deterioration in display quality of the liquid crystal panel 220.

It should be noted that HAZE is a value that is calculated according to the following formula:

HAZE (%)=Td/Tt×100,

where Td is diffusion transmittance and Tt is total transmittance.
This means that when the light source is parallel light, a light of (1-HAZE) (%) travels frontward and a light of HAZE (%) travels (scatters) in directions other than the frontward direction.

Therefore, a larger value of HAZE means inconveniences such as a blurred display (blurring), a decrease in contrast, and a display that looks dark, etc.

Furthermore, formation of such projections 250d makes it possible to improve the ease with which the elastic films 250a and 250b become separated from each other when released from pressure after a finger, an input pen, or the like applies pressure to the detector surface 300a and brings the elastic films 250a and 250b into contact with each other. This makes it possible to prevent the elastic films 250a and 250b from keeping sticking to each other instead of becoming separated again from each other after completion of an input to the area sensor.

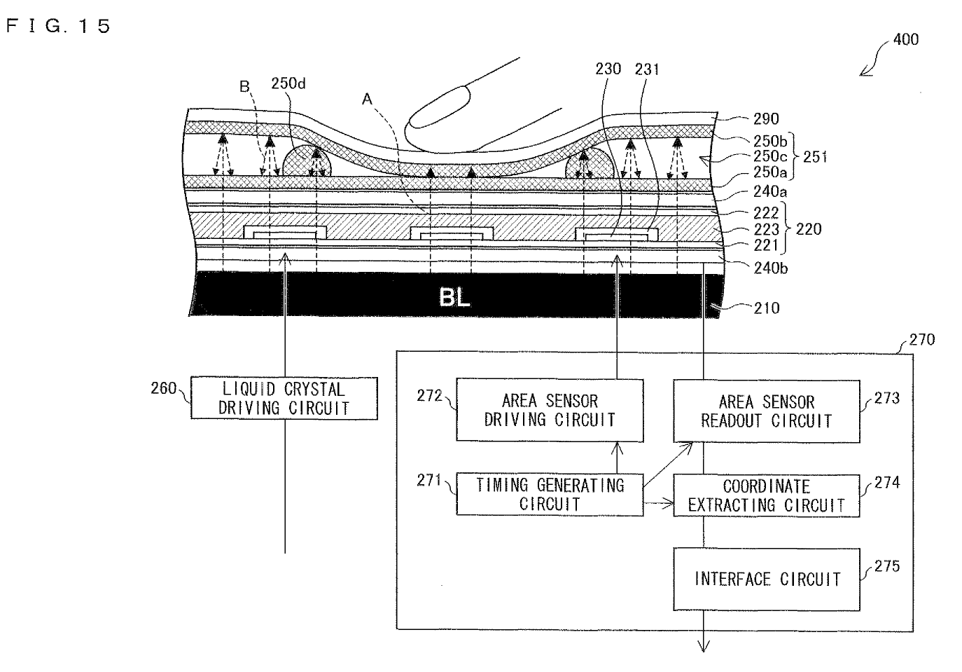

Further, although the embodiment above has been described by taking as an example a case where the reflectance changing section 250 is disposed below the front-side polarizing plate 240a, the present invention is not limited to such a configuration. FIG. 15 shows another example configuration of the present invention.

FIG. 15 shows a liquid crystal display device 400 having a reflectance changing section 251 formed above the front-side polarizing plate 240a. The reflectance changing section 251 is identical in specific structure to the reflectance changing section 250 of the liquid crystal display device 300. The liquid crystal display device 400 shown in FIG. 15 is identical to the liquid crystal display device 300 except for the way in which the front-side polarizing plate 240a and the reflectance changing section 251 are disposed and, therefore, is not described below.

According to such a configuration, in a region in the surface of the liquid crystal display device 400 that a finger or the like is not in touch with, most of the light from the backlight 210 is reflected within the reflectance changing section 251 as indicated by arrows B in FIG. 15. Meanwhile, in a region in the surface of the liquid crystal display device 400 that a finger or the like is in touch with, most of the light from the backlight 210 is transmitted as indicated by arrows A in FIG. 15, with the result that the reflectance lowers. This makes it possible to more accurately detect the presence or absence of a touch with the panel surface, as compared to the conventional area-sensor-equipped liquid crystal display device.

It should be noted, however, that in order to achieve an area sensor that is high in detection performance independently of the state of a display being carried out by a liquid crystal device (even when the display is dark), it is preferable that a reflectance changing section be disposed below the front-side polarizing plate 240a.

Further, although, in the embodiment above, the two elastic films 250a and 250b are laminated in this order on the support film 250e so that the air layer 250e is formed between the two elastic films, the present invention is not limited to such a configuration. In the present invention, a reflectance changing section needs only have at least two elastic films with an air layer formed therebetween. Therefore, the present invention encompasses a reflectance changing section that has three or more elastic films with an air layer formed between each of the elastic films and another. In such a case where there are a plurality of air layers, the variation width of reflectance of light between the presence and absence of a finger or the like touching the panel surface can be made wider than in a case where there is only one air layer.

### Embodiment 4

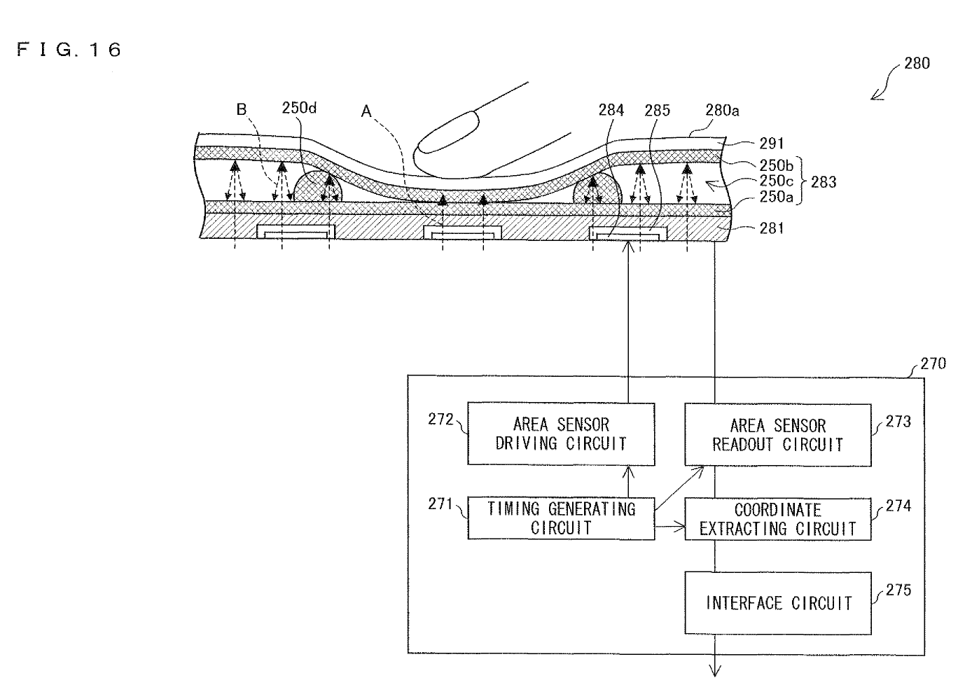

A fourth embodiment of the present invention is described below with reference to FIG. 16. It should be noted that the present invention is not limited, to this.

In Embodiment 3 above, a touch-panel-integrated liquid crystal display device having an area sensor function (specifically, a touch panel function) has been described. In Embodiment 4, an area sensor not integrated with a display device is described.

FIG. 16 shows an area sensor 280 having a touch panel function of detecting the position of an input through detection of an image on a detector surface 280a by a plurality of light sensor elements 284 provided on a substrate 281.

As shown in FIG. 16, the area sensor 280 includes the substrate 281 (position detecting section) having the plurality of light sensor elements 284. The area sensor 280 may further include a light-emitting section (not illustrated), provided toward a back surface of the substrate 281 (toward that surface of the substrate 281 which faces away from the detector surface 280a), which irradiates the substrate with light. Each of the light sensor elements 284 is formed by a photodiode or a phototransistor and detects the amount of received light by passing therethrough a current corresponding to the intensity of the received light. A method for forming such a light sensor element can be carried out according to a conventionally publicly known method for manufacturing an area sensor.

Further, the area sensor 280 of the present embodiment has visible light blocking filters 285, provided on those respective sides of the light sensor elements 284 which face the detector surface 280a and between the substrate 281 (surface of the substrate 281 that faces away from the detector surface 280a) and a reflectance changing section 283, which does not transmit visible light. Furthermore, the area sensor 280 of the present embodiment has an infrared and ultraviolet light blocking filter 291, provided on that side of the reflectance changing section 283 which faces the detector surface 280a, which transmits neither infrared or ultraviolet light. The workings of the visible light blocking filters 285 and of the infrared and ultraviolet light blocking filter 291 and the types of light that enter the light sensor elements 284 are not described in detail here, because the arrangements (workings of the visible light blocking filter 31, of the infrared light blocking filter 90, and of the ultraviolet light blocking filter [front-side polarizing plate 40a] and the types of light that enter the light sensor elements 30) of Embodiment 1 above can be applied here.

Further, the area sensor 280 is provided with an area sensor control section 270 for driving the area sensor. As shown in FIG. 16, the area sensor control section 270 includes a timing generating circuit 271, an area sensor driving circuit 272, an area sensor readout circuit 273, a coordinate extracting circuit 274, and an interface circuit 275. The configuration of the area sensor control section is not described in detail here, because the configuration of Embodiment 3 above or the conventionally publicly known configuration can be applied here.

By having such a configuration, the area sensor 280 allows the light sensor elements 284 formed on the substrate 281 to detect the position of an input by capturing as an image a finger or input pen touching the detector surface 280a.

Moreover, the area sensor 280 of the present embodiment has the reflectance changing section 283 formed on the substrate 281. As shown in FIG. 16, the reflectance changing section 283 is structured such that the air layer 250c is formed between the two elastic films 250a and 250b with no pressure being applied to the detector surface 280a and that the two elastic films 250a and 250b makes contact with each other with pressure being applied to the detector surface 280a. Moreover, the elastic film 250a is provided with the projections 250d (distance maintaining parts) so that the air layer 250c is surely formed. The structure of the reflectance changing section 283 is not described in detail here, because the structure of any reflectance changing section described in Embodiment 3 can be applied here.

The foregoing configuration allows the reflectance of light to lower when a finger, an input pen, or the like makes contact with the detector surface 280a and applies pressure to it. This makes it possible to accurately detect whether or not the finger or input pen is in touch with the detector surface 280a.

The present invention is not limited to the description of the embodiments above, but may be altered by a skilled person within the scope of the claims. An embodiment based on a proper combination of technical means altered appropriately within the scope of the claims or of technical means disclosed in different embodiments is encompassed in the technical scope of the present invention.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention can suitably used for a display device having an area sensor function.

### REFERENCE SIGNS LIST

10 Backlight (light-emitting section)
20 Liquid crystal panel (position detecting section)
21 Active matrix substrate
22 Counter substrate
23 Liquid crystal layer
30 Light sensor element
31 Visible light blocking filter
40a Front-side polarizing plate (flat-plate transparent substrate, image display surface-side polarizing plate, ultraviolet light blocking filter)
40b Back-side polarizing plate
45 Reflectance changing section
46 Reflectance changing section
50 Elastic film
70 Area sensor control section
80 Area sensor
80a Detector surface
83 Reflectance changing section
84 Light sensor element
85 Visible light blocking filter
90 Infrared light blocking filter
91 Infrared and ultraviolet light blocking filter
100 Liquid crystal display device (display device)
100a Panel surface (detector surface)
210 Backlight (light-emitting section)
220 Liquid crystal panel (position detecting section)
221 Active matrix substrate
222 Counter substrate
223 Liquid crystal layer
230 Light sensor element
231 Visible light blocking filter
240a Front-side polarizing plate (image display surface-side polarizing plate, ultraviolet light blocking filter)
240b Back-side polarizing plate
250 Reflectance changing section
251 Reflectance changing section
250a Elastic film
250b Elastic film
250c Air layer
250d Projection (distance maintaining part)
250e Support film (support)
270 Area sensor control section
280 Area sensor
280a Detector surface
283 Reflectance changing section
284 Light sensor element
285 Visible light blocking filter
290 Infrared light blocking filter
291 Infrared and ultraviolet light blocking filter
300 Liquid crystal display device (display device)
300a Panel surface (detector surface)

1. An area sensor for detecting the position of an input from an outside source by detecting an image on a detector surface,
the area sensor comprising:
a position detecting section, provided with a plurality of light sensor elements that detects the intensity of received light, which detects the position of an input through detection of an image on the detector surface by the light sensor elements; and
a reflectance changing section, provided on that side of the position detecting section which faces the detector surface, which effects a change in reflectance of light when pressure is applied to the detector surface,
the area sensor further comprising:
an infrared light blocking filter and an ultraviolet light blocking filter both provided on that side of the reflectance changing section which faces the detector surface; and
visible light blocking filters provided on those respective sides of the light sensor elements which face the detector surface and between the position detecting section and the reflectance changing section.

2. The area sensor as set forth in claim 1, further comprising a light-emitting section for irradiating the position detecting section with light containing at least infrared light or ultraviolet light from behind.

3. The area sensor as set forth in claim 1, wherein the reflectance changing section lowers reflectance when under pressure.

4. The area sensor as set forth in claim 3, wherein the reflectance changing section is a laminate of (i) an elastic film and (ii) a flat-plate transparent substrate.

5. The area sensor as set forth in claim 4, wherein the elastic film has irregularities formed therein.

6. The area sensor as set forth in claim 3, wherein the reflectance changing section has at least two elastic films and an air layer formed between the two elastic films with no pressure being applied to the detector surface, and is structured such that the two elastic films makes contact with each other when pressure is applied to the detector surface.

7. The area sensor as set forth in claim 6, wherein the reflectance changing section has distance maintaining parts provided on at least either of the two elastic films so that the air layer is formed.

8. A display device having a display panel including an area sensor as set forth in claim 1.

9. A liquid crystal display device (i) including a liquid crystal panel having an active matrix substrate, a counter substrate, and a liquid crystal layer disposed therebetween and (ii) having an area sensor function of detecting the position of an input from an outside source by detecting an image on a panel surface,
the liquid crystal display device comprising:
a position detecting section, provided with a plurality of light sensor elements that detects the intensity of received light, which detects the position of an input from an outside source through detection of an image on the panel surface by the light sensor elements; and
a reflectance changing section, provided on that side of the position detecting section which faces the panel surface, which effects a change in reflectance of light when pressure is applied to the panel surface,
the liquid crystal display device further comprising:
an infrared light blocking filter and an ultraviolet light blocking filter both provided on that side of the reflectance changing section which faces the panel surface; and
visible light blocking filters provided on those respective sides of the light sensor elements which face the panel surface and between the position detecting section and the reflectance changing section.

10. The liquid crystal display device as set forth in claim 9, wherein the ultraviolet light blocking filter is a polarizing plate.

11. The liquid crystal display device as set forth in claim 9, further comprising a backlight for irradiating the liquid crystal panel with light containing at least infrared light or ultraviolet light from behind.

12. The liquid crystal display device as set forth in claim 9, wherein the reflectance changing section lowers reflectance when under pressure.

13. The liquid crystal display device as set forth in claim 12, wherein:
the liquid crystal panel is provided between two polarizing plates disposed opposite each other;
the reflectance changing section is a laminate of (i) that one of the polarizing plates which is provided toward an image display surface and (ii) an elastic film; and
the elastic film is disposed between the liquid crystal panel and the polarizing plate provided toward the image display surface.

14. The liquid crystal display device as set forth in claim 13, wherein the elastic film has irregularities formed therein.

15. The liquid crystal display device as set forth in claim 12, wherein the reflectance changing section has at least two elastic films and an air layer formed between the two elastic films with no pressure being applied to the panel surface, and is structured such that the two elastic films makes contact with each other when pressure is applied to the panel surface.
